(19) United States
(12) Patent Application Publication
(10) Pub. No.: US 2024/0265687 A1
(43) Pub. Date: Aug. 8, 2024

(54) METHOD OF FUSING IMAGE FEATURE, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Bi LI, Beijing (CN); Nan PENG, Beijing (CN); Teng XI, Beijing (CN); Gang ZHANG, Beijing (CN)

(73) Assignee: BEIJING BAIDU NETCOM SCIENCE TECHNOLOGY CO., LTD., Beijing (CN)

(21) Appl. No.: 18/020,396

(22) PCT Filed: Apr. 22, 2022
(86) PCT No.: PCT/CN2022/088397

§ 371 Date: Feb. 8, 2023

(30) Foreign Application Priority Data
Aug. 16, 2021 (CN) 202110940534.2

(51) Int. Cl. G06V 10/80; G06V 10/77

(52) U.S. Cl. CPC G06V 10/806; G06V 10/7715

(57) ABSTRACT

A method of fusing an image feature, an electronic device, and a storage medium are provided, which relate to the field of artificial intelligence, in particular to fields of computer vision and depth learning, and may be applied to scenarios such as image processing and image recognition. The method includes: inputting an image into a first image processing model among N serially connected image processing models, to obtain an output feature of the first image processing model, an i-th image processing model includes a first shared layer to an i-th shared layer, i=1, . . . , N, and N is a natural number greater than or equal to 2; inputting an output feature of a j-th image processing model into a (j+1)-th image processing model, to obtain an output feature of the (j+1)-th image processing model, j=1, . . . , N−1; and fusing the output features of the N image processing models.

This application claims priority to Chinese Patent Application No. 202110940534.2. filed on Aug. 16, 2021, the entire content of which is incorporated herein in its entirety by reference.

### TECHNICAL FIELD

The present disclosure relates to the field of artificial intelligence technology, in particular to fields of computer vision and deep learning technology, which may be applied to scenarios such as image processing and image recognition. More specifically, the present disclosure provides a method and an apparatus of fusing an image feature, an electronic device, and a storage medium.

### BACKGROUND

The multi-model feature fusion refers to designing and training a plurality of models to solve the same problem, using all models to predict in a deployment phase to obtain a plurality of features, and then fusing a plurality of predicted features into a final feature. The multi-model feature fusion may be applied to scenarios such as image processing and image recognition.

### SUMMARY

The present disclosure provides a method and an apparatus of fusing an image feature, a device, and a storage medium.

According to a first aspect, a method of fusing an image feature is provided, including: inputting an image to be processed into a first image processing model among N image processing models, so as to obtain an output feature of the first image processing model, wherein the N image processing models are serially connected, and an i-th image processing model among the N image processing models includes a first shared layer to an i-th shared layer, wherein i=1, . . . , N, and N is a natural number greater than or equal to 2; inputting an output feature of a j-th image processing model into a (j+1)-th image processing model, so as to obtain an output feature of the (j+1)-th image processing model, wherein j=1, . . . , N−1; and fusing the output features of the N image processing models to obtain a fused feature.

According to a second aspect, an apparatus of fusing an image feature is provided, including: a first obtaining module configured to input an image to be processed into a first image processing model among N image processing models, so as to obtain an output feature of the first image processing model, wherein the N image processing models are serially connected, and an i-th image processing model among the N image processing models includes a first shared layer to an i-th shared layer, wherein i=1, . . . , N, and N is a natural number greater than or equal to 2; a second obtaining module configured to input an output feature of a j-th image processing model into a (j+1)-th image processing model, so as to obtain an output feature of the (j+1)-th image processing model, wherein j=1, . . . , N−1; and a fusion module configured to fuse the output features of the N image processing models to obtain a fused feature.

According to a third aspect, an electronic device is provided, including: at least one processor; and a memory communicatively connected to the at least one processor, wherein the memory stores instructions executable by the at least one processor, and the instructions, when executed by the at least one processor, cause the at least one processor to implement the method provided according to the present disclosure.

According to a fourth aspect, a non-transitory computer-readable storage medium having computer instructions stored thereon is provided, wherein the computer instructions are configured to cause a computer to implement the method provided according to the present disclosure.

According to a fifth aspect, a computer program product containing a computer program/instruction is provided, wherein the computer program/instruction, when executed by a processor, causes the processor to implement the method provided according to the present disclosure.

It should be understood that content described in this section is not intended to identify key or important features in the embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used to understand the present disclosure better and do not constitute a limitation to the present disclosure, in which:

FIG. 1 is a schematic diagram of an exemplary system architecture to which a method and an apparatus of fusing an image feature may be applied according to an embodiment of the present disclosure;

FIG. 2 is a flowchart of a method of fusing an image feature according to an embodiment of the present disclosure;

FIG. 3 is a flowchart of a method of fusing an image feature according to another embodiment of the present disclosure;

FIG. 4 is a schematic diagram of a model applying a method of fusing an image feature according to an embodiment of the present disclosure;

FIG. 5 is a block diagram of an apparatus of fusing an image feature according to an embodiment of the present disclosure; and

FIG. 6 is a block diagram of an electronic device for a method of fusing an image feature according to an embodiment of the present disclosure.

### DETAILED DESCRIPTION OF EMBODIMENTS

Exemplary embodiments of the present disclosure will be described below with reference to the accompanying drawings, which include various details of the embodiments of the present disclosure to facilitate understanding and should be considered as merely exemplary. Therefore, those of ordinary skilled in the art should realize that various changes and modifications may be made to the embodiments described herein without departing from the scope and spirit of the present disclosure. Likewise, for clarity and conciseness, descriptions of well-known functions and structures are omitted in the following description.

Applying the multi-model for feature fusion requires deploying a plurality of models and using the deployed plurality of models for prediction, which requires a relative high computing ability. When applying the multi-model to process or recognize an image, the plurality of models are independent from each other. Each of the plurality of models processes input data independently and generates its own output feature independently, and then output features of each image processing model are spliced to generate a final output feature.

For example, output features of N image processing models are (a11, a12), (a21, a22, a23, a24), . . . , (ai1, ai2, . . . , aiq), . . . , (aN1, aN2, . . . , aNm). The output features of the N image processing models are spliced to obtain a final output feature (a11, a12, a21, a22, a23, a24, . . . , ai1, ai2, . . . , aiq, . . . , aN1, aN2, . . . , aNm). An output feature of an i-th image processing model is a q-dimensional vector, an output feature of an N-th image processing model is a m-dimensional vector, and m≥2 and q≥2. In an example, when N=3, there are output features of three image processing models, namely (a11, a12). (a21, a22, a23, a24). and (a31, a32). The output features of the three image processing models are spliced to obtain a final output feature (a11, a12, a21, a22, a23, a24, a31, a32). It may be seen that a dimension of the feature is proportional to the number of model, which requires a relative high storage ability. In addition, each model operates independently, and a total amount of calculation is also proportional to the number of models, so the amount of calculation is relative large.

Therefore, in order to use the multi-model for feature fusion, devices for computing and storage may be added, and the multi-model may be optimized to reduce computing or storage pressure. Adding devices for computing and storage will significantly increase costs and is not sustainable In addition, optimizing the multi-model, such as reducing the number of models, using a plurality of small models to reduce the amount of calculation, or using a principal component analysis to reduce a dimension of a final output feature, will reduce the effect of image recognition or image processing, which weakens the improvement of image processing or image recognition effect brought about by the fusion by using the multi-model. In addition, the principal component analysis is a two-phase scheme, which requires training each model first, and then training a linear mapping matrix to reduce a dimension of the feature An operation of the principal component analysis is not simple enough, which brings additional deployment costs.

It should be noted that, in the technical solution of the present disclosure, the collection, storage, use, processing, transmission, provision, disclosure and application of the user's personal information involved are all in compliance with the relevant laws and regulations, and necessary confidentiality measures have been taken, and do not violate the public order and good customs.

In the technical solution of the present disclosure, the authorization or consent of the user is acquired before the user's personal information is acquired or collected.

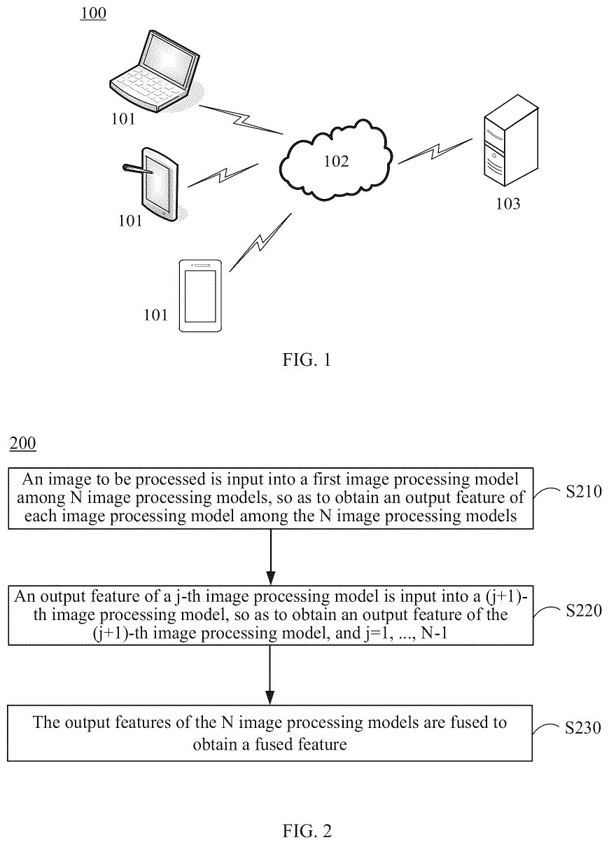

FIG. 1 is an exemplary system architecture to which a method and an apparatus of fusing an image feature may be applied according to an embodiment of the present disclosure. It should be noted that FIG. 1 is only an example of a system architecture to which the embodiments of the present disclosure may be applied, so as to help those skilled in the art to understand the technical content of the present disclosure, but it does not mean that the embodiments of the present disclosure cannot be used for other devices, systems, environment or scenes.

As shown in FIG. 1, a system architecture 100 according to this embodiment may include a plurality of terminal devices 101, a network 102 and a server 103. The network 102 is a medium used to provide a communication link between the terminal device 101 and the server 103. The network 102 may include various connection types, such as wired and/or wireless communication links, and the like.

A user may use the terminal device 101 to interact with the server 103 through the network 102 to receive or send a massage and the like. The terminal device 101 may be various electronic devices, including but not limited to a smart phone, a tablet, a laptop, and the like.

The method of fusing an image feature provided by the embodiments of the present disclosure may generally be executed by the server 103. Correspondingly, the apparatus of fusing an image feature provided by the embodiments of the present disclosure may be disposed in the server 103. The method of fusing an image feature provided by the embodiments of the present disclosure may also be executed by a server or a server cluster different from the server 103 and capable of communicating with the terminal 101 and/or the server 103. Correspondingly, the apparatus of fusing an image feature provided by the embodiments of the present disclosure may also be provided in the server or the server cluster different from the server 103 and capable of communicating with the terminal device 101 and/or the server 103.

FIG. 2 is a flowchart of a method of fusing an image feature according to an embodiment of the present disclosure.

As shown in FIG. 2, a method 200 of fusing an image feature may include operations S210 to S230.

In operation S210, an image to be processed is input into a first image processing model among N image processing models, so as to obtain an output feature of the first image processing model.

For example, the N image processing models are serially connected, an i-th image processing model among the N image processing models includes a first shared layer to an i-th shared layer, i=1, . . . , N, and N is a natural number greater than or equal to 2.

For another example, an (i+1)-th image processing model among the N image processing models shares the first shared layer to the i-th shared layer with the i-th image processing model. That is, the (i+1)-th image processing model shares the output of the first i image processing models.

In the embodiment of the present disclosure, the shared layer may include at least one processing layer.

For example, the shared layer includes h convolutional layers, and h≥1. Accordingly, the first image processing model includes h convolutional layers, the i-th image processing model includes i*h convolutional layers, and the N-th image processing model includes N*h convolutional layers. In an example, the shared layer includes one convolutional layer, that is, h=1. Accordingly, the first image processing model includes 1*1=1 convolutional layer, the i-th image processing model includes 1*i=i convolutional layers, and the N-th image processing model includes 1*N=N convolutional layers.

It should be understood that the processing layer may be a convolutional layer, a fully connected layer, a hidden layer, a pooling layer, or the like, which may be used to process an image or an image feature. The present disclosure is not limited thereto.

In the embodiment of the present disclosure, the shared layers may have the same structure, and parameters between a plurality of shared layers may be different.

For example, the shared layer includes one convolutional layer, the first image processing model includes a first convolutional layer, and the second image processing model includes two convolutional layers (the first convolutional layer and a second convolutional layer). A convolution kernel size and a convolution kernel parameter of the second convolutional layer may be same as or different from those of the first convolutional laver. In an example, a convolution kernel in the first convolutional layer is a convolution kernel of 3×3, while a convolution kernel in the second convolutional layer is a convolution kernel of 4×4. In an example, the convolution kernel in the first convolutional layer is a convolution kernel of 3×3, and the convolution kernel in the second convolutional layer is also a convolution kernel of 3×3.

In operation S220, an output feature of a j-th image processing model is input into a (j+1)-th image processing model, so as to obtain an output feature of the (j+1)-th image processing model, and j=1, . . . , N−1.

For example, the output feature of the first image processing model may be input into the second image processing model, so as to obtain an output feature of the second image processing model.

In operation S230, the output features of the N image processing models are fused to obtain a fused feature.

In the embodiment of the present disclosure, the output features of the N image processing models are added to obtain the fused feature.

For example, the output features of the N image processing models are (a11, a12, . . . a1k), (a21, a22, . . . , a2k), . . . , (ai1, ai2, . . . , aik), . . . , (aN1, aN2, . . . , aNk) respectively. The output features of the N image processing models are added to obtain a fused feature (a11+a21+ . . . +ai1+ . . . +aN1, a12+a22+ . . . +ai2+aN2, . . . , a1k+a2k+ . . . +aik+ . . . +aNk), the output feature of the i-th image processing model is a k-dimensional vector, the output feature of the N-th image processing model is a k-dimensional vector, and k≥2. In an example, when N=3, there are output features of three image processing models, namely (a11, a12). (a21, a22) and (a31, a32). The output features of the three image processing models are added to obtain a fused feature (a11+a21+a31, a12+a22+a32). Since feature addition is a simple post-processing process, it reduces the difficulty of deployment compared with the principal component analysis.

Through the embodiments of the present disclosure, the plurality of models use the shared layer, greatly reducing the amount of computation and storage and reducing the deployment cost, which is a sustainable solution. Larger and more models may be used for feature fusion, so as to ensure the recognition accuracy.

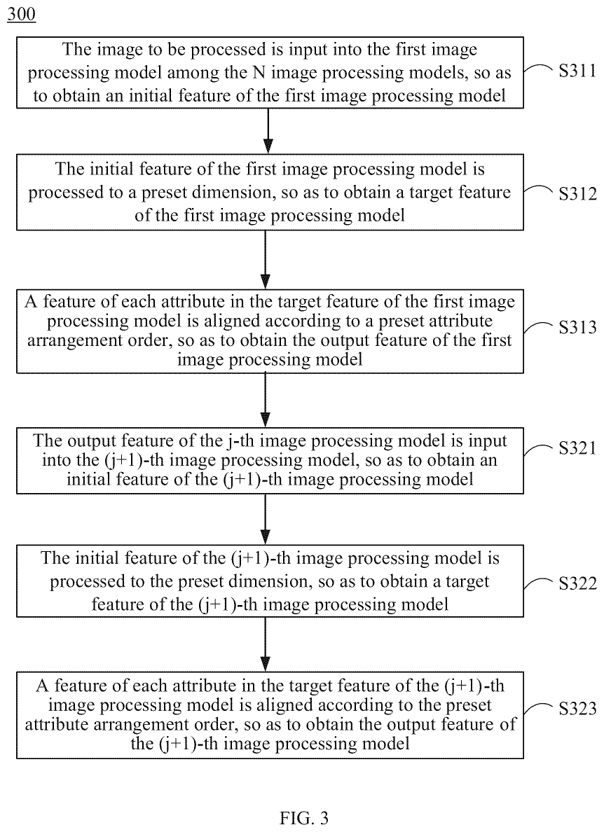

FIG. 3 is a flowchart of a method of fusing an image feature according to another embodiment of the present disclosure.

As shown in FIG. 3, a method 300 of fusing an image feature may input an image to be processed into a first image processing model among N image processing models, so as to obtain an output feature of the first image processing model. The following operations S311 to S313 will be referred to for detailed description.

In operation S311, the image to be processed is input into the first image processing model among the N image processing models, so as to obtain an initial feature of the first image processing model.

In the embodiment of the present disclosure, the image to be processed is input into the first image processing model, so as to obtain the initial feature of the first image processing model.

For example, the image to be processed is input into the first image processing model and processed by a first shared layer, so as to obtain the initial feature of the first image processing model.

In operation S312, the initial feature of the first image processing model is processed to a preset dimension, so as to obtain a target feature of the first image processing model.

For example, the target feature of the first image processing model includes k dimensions.

In operation S313, a feature of each attribute in the target feature of the first image processing model is aligned according to a preset attribute arrangement order, so as to obtain the output feature of the first image processing model.

In the embodiment of the present disclosure, an attribute represented by a feature of each dimension in the target feature of the first image processing model is determined.

For example, the target feature of the first image processing model is (a11, a12, a13, . . . , a1k), a11 represents a height of the image and a12 represents a color of the image.

In the embodiment of the present disclosure, each dimension of the target feature of the first image processing model is adjusted according to the preset attribute arrangement order.

For example, the target feature of the first image processing model is (a11, a12, . . . , a1k), a11 represents the height of the image and a12 represents the color of the image. The preset attribute arrangement order is: a feature of a first dimension represents a first attribute (such as the height of the image) of the image, a feature of a second dimension represents a second attribute (such as the color of the image) of the image, . . . , a feature of a k-th dimension represents a k-th attribute of the image. After adjustment, the output feature of the first image processing model is (a11, a12. . . . , a1k), and attributes represented by a13 to a1k in the target feature of the first image processing model conform to the preset attribute arrangement order.

Next, the method 300 of fusing an image feature may input an output feature of a j-th image processing model into a (j+1)-th image processing model, so as to obtain an output feature of the (j+1)-th image processing model, and j=1, . . . , N−1. The following operations S321 to S323 will be referred to for detailed description.

In operation S321, the output feature of the j-th image processing model is input into the (j+1)-th image processing model, so as to obtain an initial feature of the (j+1)-th image processing model.

For example, when j=1, an output feature of the first image processing model is input into a second image processing model, so as to obtain an initial feature of the second image processing model.

For another example, initial features of N image processing models may be obtained, such as the initial feature of the first image processing model, the initial feature of the second image processing model, . . . , an initial feature of the i-th image processing model, . . . , and an initial feature of the N-th image processing model. Dimensions of these N initial features may be the same or different.

In operation S322, the initial feature of the (j+1)-th image processing model is processed to the preset dimension, so as to obtain a target feature of the (j+1)-th image processing model.

In the embodiment of the present disclosure, a dimension of target features of N image processing models is not less than a dimension of an initial feature of an image processing model having the greatest dimension among the initial features of N image processing models.

For example, if the dimension of the initial feature of the image processing model having the greatest dimension among the initial features of N image processing models is p and the preset dimension is k, k is greater than or equal to p.

For example, a target feature of the N-th image processing model is (aN1, aN2, aN3, . . . , aNk).

In operation S323, a feature of each attribute in the target feature of the (j+1)-th image processing model is aligned according to the preset attribute arrangement order, so as to obtain the output feature of the (j+1)-th image processing model.

In the embodiment of the present disclosure, an attribute represented by a feature of each dimension in the target feature of the (j+1)-th image processing model is determined.

For example, the target feature of the N-th image processing model is (aN1, aN2, aN3, . . . , aNk), aN2 represents the height of the image and aN1 represents the color of the image.

In the embodiment of the present disclosure, each dimension of the target feature of the (j+1)-th image processing model is adjusted according to the preset attribute arrangement order.

For example, the preset attribute arrangement order is: the feature of the first dimension represents the first attribute (such as the height of the image) of the image, the feature of the second dimension represents the second attribute (such as the color of the image) of the image, . . . , the feature of the k-th dimension represents the k-th attribute of the image. After adjustment, the output feature of the N-th image processing model is (aN2, aN1, . . . , aNk). After adjustment, an attribute represented by a first dimension of output features of other image processing models should be the same as those represented by a11 or aN2. Attributes represented by aN3 to aNk in the target feature of the N-th image processing model conform to the preset attribute arrangement order.

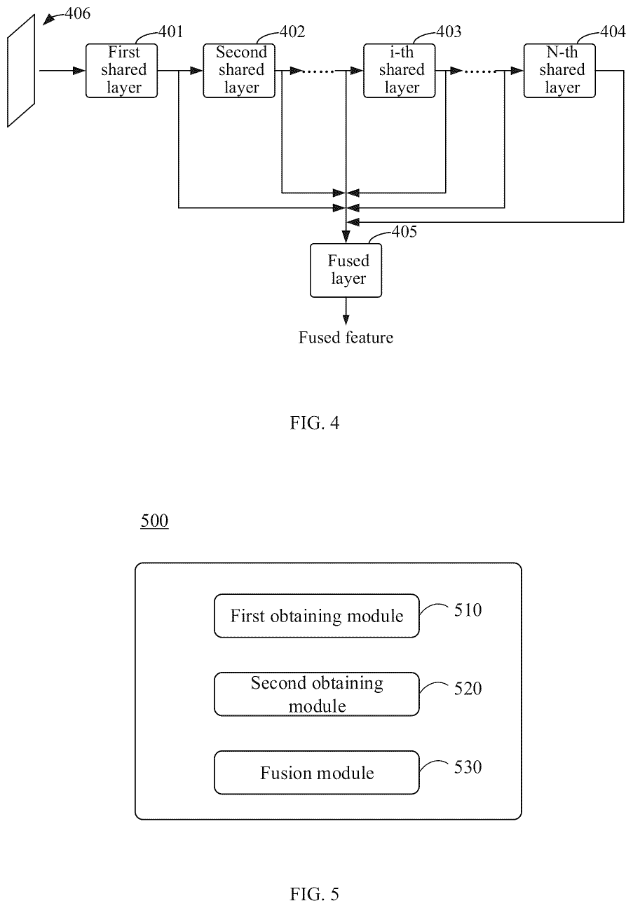

FIG. 4 is a schematic diagram of a model applying a method of fusing an image feature according to an embodiment of the present disclosure.

As shown in FIG. 4, the model includes operating the first image processing model, the second image processing model, . . . , the i-th image processing model, . . . , and the N-th image processing model.

The first image processing model includes a first shared layer 401. The second image processing model includes the first shared layer 401 and a second shared layer 402. An input of the first shared layer 401 is an image 406. The output feature of the first image processing model is generated based on an output of the first shared layer 401. The output feature of the first image processing model is used as an output of the first image processing model and an input of the second shared layer. The output feature of the second image processing model is generated based on an output of the second shared layer 402. The output feature of the second image processing model is used as an output of the second image processing model and an input of a third shared layer.

The i-th image processing model includes the first shared layer 401, the second shared layer 402, . . . , and an i-th shared layer 403. An input of the i-th shared layer 403 is an output feature of an (i−1)-th image processing model. In an example, i=3.

An output feature of the i-th image processing model is generated based on an output of the i-th shared layer 403. The output feature of the i-th image processing model is used as an output of the i-th image processing model and an input of the (i+1)-th shared layer.

The N-th image processing model includes the first shared layer 401, the second shared layer 402, . . . , the i-th shared layer 403, . . . , and an N-th shared layer 404. An input of the N-th shared layer 404 is an output feature of an (N−1)-th image processing model. In an example. N=4.

An output feature of the N-th image processing model is generated based on an output of the N-th shared layer 404. The output feature of the N-th image processing model is used as an output of the N-th image processing model.

The output feature of the first image processing model. the output feature of the second image processing model, . . . , the output feature of the i-th image processing model, . . . , and the output feature of the N-th image processing model are input into a fusing layer 405 for feature fusion, so as to obtain a fused feature.

In some embodiments, the output of the first shared layer 401 may be directly used as the output feature of the first image processing model, the output of the second shared layer 402 may be directly used as the output feature of the second image processing model, . . . , an output of the i-th shared layer 403 may be directly used as the output feature of the i-th image processing model. and an output of the N-th shared layer 404 may be directly used as the output feature of the N-th image processing model.

In some embodiments, the first shared layer 401, the second shared layer 402, . . . , the i-th shared layer 403, . . . , and an N-th shared layer 404 are connected to a shared fully connected layer respectively.

The output of the first shared layer 401 is the initial feature of the first image processing model. The shared fully connected layer generates the output feature of the first image processing model according to the initial feature of the first image processing model. The output of the second shared layer 402 is the initial feature of the second image processing model. The shared fully connected layer generates the output feature of the second image processing model according to the initial feature of the second image processing model, . . . . The output of the i-th shared layer 403 is the initial feature of the i-th image processing model. The shared fully connected layer generates the output feature of the i-th image processing model according to the initial feature of the i-th image processing model, . . . . The output of the N-th shared layer 404 is the initial feature of the N-th image processing model. The shared fully connected layer generates the output feature of the N-th image processing model according to the initial feature of the N-th image processing model.

FIG. 5 is a block diagram of an apparatus of fusing an image feature according to an embodiment of the present disclosure.

As shown in FIG. 5, an apparatus 500 of fusing an image feature may include a first obtaining module 510, a second obtaining module 520, and a fusion module 530.

The first obtaining module 510 is used to input an image to be processed into a first image processing model among N image processing models, so as to obtain an output feature of the first image processing model, the N image processing models are serially connected, an i-th image processing model among the N image processing models includes a first shared layer to an i-th shared layer, i=1, . . . , N, and N is a natural number greater than or equal to 2.

The second obtaining module 520 is used to input an output feature of a j-th image processing model into a (j+1)-th image processing model, so as to obtain an output feature of the (j+1)-th image processing model, and j=1, . . . , N−1.

The fusion module 530 is used to fuse the output features of the N image processing models to obtain a fused feature.

In some embodiments, an (i+1)-th image processing model among the N image processing models shares the first shared layer to the i-th shared layer with the i-th image processing model.

In some embodiments, the fusion module includes an addition sub-module ussed to add the output features of the N image processing models to obtain the fused feature.

In some embodiments, the first obtaining module includes a first obtaining sub-module used to input the image to be processed into the first image processing model among the N image processing models, so as to obtain an initial feature of the first image processing model; a first processing sub-module used to process the initial feature of the first image processing model to a preset dimension, so as to obtain a target feature of the first image processing model; and a first alignment sub-module used to align a feature of each attribute in the target feature of the first image processing model according to a preset attribute arrangement order, so as to obtain the output feature of the first image processing model.

In some embodiments, the second obtaining module includes a second obtaining sub-module used to input the output feature of the j-th image processing model into the (j+1)-th image processing model, so as to obtain an initial feature of the (j+1)-th image processing model; a second processing sub-module used to process the initial feature of the (j+1)-th image processing model to the preset dimension, so as to obtain a target feature of the (j+1)-th image processing model; and a second alignment sub-module used to align a feature of each attribute in the target feature of the (j+1)-th image processing model according to the preset attribute arrangement order, so as to obtain the output feature of the (j+1)-th image processing model.

In some embodiments, the first aligning sub-module includes a first determination unit used to determine an attribute represented by a feature of each dimension in the target feature of the first image processing model; and a first adjustment unit used to adjust each dimension of the target feature of the first image processing model according to the preset attribute arrangement order. The second alignment sub-module includes: a second determination unit used to determine an attribute represented by a feature of each dimension in the target feature of the (j+1)-th image processing model; and a second adjustment unit used to adjust each dimension of the target feature of the (j+1)-th image processing model according to the preset attribute arrangement order.

According to an embodiment of the present disclosure, the present disclosure further provides an electronic device, a readable storage medium, and a computer program product.

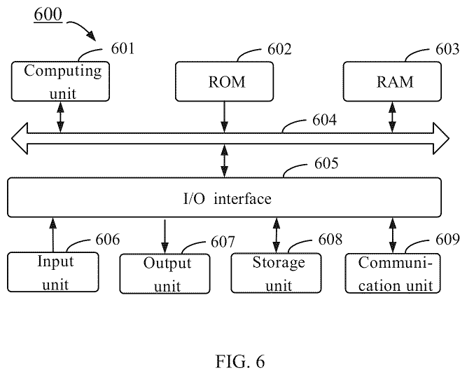

FIG. 6 shows a schematic block diagram of an exemplary electronic device 600 for implementing the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 6, the device 600 may include a computing unit 601, which may perform various appropriate actions and processing based on a computer program stored in a read-only memory (ROM) 602 or a computer program loaded from a storage unit 608 into a random access memory (RAM) 603. Various programs and data required for the operation of the device 600 may be stored in the RAM 603. The computing unit 601, the ROM 602 and the RAM 603 are connected to each other through a bus 604. An input/output (I/O)) interface 605 is further connected to the bus 604.

Various components in the device 600, including an input unit 606 such as a keyboard, a mouse, etc., an output unit 607 such as various types of displays, speakers, etc., a storage unit 608 such as a magnetic disk, an optical disk, etc., and a communication unit 609 such as a network card, a modem, a wireless communication transceiver, etc., are connected to the I/O interface 605. The communication unit 609 allows the device 600 to exchange information/data with other devices through a computer network such as the Internet and/or various telecommunication networks.

The computing unit 601 may be various general-purpose and/or special-purpose processing components with processing and computing capabilities. Some examples of the computing unit 601 include but are not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, and so on. The computing unit 601 may perform the various methods and processes described above, such as the method of fusing an image feature. For example, in some embodiments, the method of fusing an image feature may be implemented as a computer software program that is tangibly contained on a machine-readable medium, such as a storage unit 608. In some embodiments, part or all of a computer program may be loaded and/or installed on the device 600 via the ROM 602 and/or the communication unit 609. When the computer program is loaded into the RAM 603 and executed by the computing unit 601, one or more steps of the method of fusing an image feature described above may be performed. Alternatively, in other embodiments, the computing unit 601 may be configured to perform the method of fusing an image feature in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input device and the at least one output device, and may transmit the data and instructions to the storage system, the at least one input device, and the at least one output device.

Program codes for implementing the method of the present disclosure may be written in any combination of one or more programming languages. These program codes may be provided to a processor or a controller of a general-purpose computer, a special-purpose computer, or other programmable data processing devices, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or the server.

In the context of the present disclosure, the machine readable medium may be a tangible medium that may contain or store programs for use by or in combination with an instruction execution system, device or apparatus. The machine readable medium may be a machine-readable signal medium or a machine-readable storage medium. The machine readable medium may include, but not be limited to, electronic, magnetic, optical, electromagnetic, infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with users, the systems and techniques described here may be implemented on a computer including a display device (for example, a CRT (cathode ray tube) or LCD (liquid crystal display) monitor) for displaying information to the user), and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example. an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with a blockchain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

1. A method of fusing an image feature, the method comprising:
inputting an image to be processed into a first image processing model among N image processing models, so as to obtain an output feature of the first image processing model, wherein the N image processing models are serially connected, and an i-th image processing model among the N image processing models comprises a first shared layer to an i-th shared layer, wherein i=1, . . . , N, and N is a natural number greater than or equal to 2;
inputting an output feature of a j-th image processing model into a (j+1)-th image processing model, so as to obtain an output feature of the (j+1)-th image processing model, wherein j=1, . . . , N−1; and
fusing the output features of the N image processing models to obtain a fused feature.

2. The method according to claim 1, wherein an (i+1)-th image processing model among the N image processing models shares the first shared layer to the i-th shared layer with the i-th image processing model.

3. The method according to claim 1, wherein the fusing the output features of the N image processing models to obtain a fused feature comprises adding the output features of the N image processing models to obtain the fused feature.

4. The method according to claim 1, wherein the inputting an image to be processed into a first image processing model among N image processing models, so as to obtain an output feature of the first image processing model comprises:
inputting the image to be processed into the first image processing model among the N image processing models, so as to obtain an initial feature of the first image processing model;
processing the initial feature of the first image processing model to a preset dimension, so as to obtain a target feature of the first image processing model; and
aligning a feature of each attribute in the target feature of the first image processing model according to a preset attribute arrangement order, so as to obtain the output feature of the first image processing model.

5. The method according to claim 4, wherein the inputting an output feature of a j-th image processing model into a (j+1)-th image processing model, so as to obtain an output feature of the (j+1)-th image processing model comprises:
inputting the output feature of the j-th image processing model into the (j+1)-th image processing model, so as to obtain an initial feature of the (j+1)-th image processing model;
processing the initial feature of the (j+1)-th image processing model to the preset dimension, so as to obtain a target feature of the (j+1)-th image processing model; and
aligning a feature of each attribute in the target feature of the (j+1)-th image processing model according to the preset attribute arrangement order, so as to obtain the output feature of the (j+1)-th image processing model.

6. The method according to claim 4, wherein the aligning a feature of each attribute in the target feature of the first image processing model according to a preset attribute arrangement order comprises:
determining an attribute represented by a feature of each dimension in the target feature of the first image processing model; and
adjusting each dimension of the target feature of the first image processing model according to the preset attribute arrangement order; and
wherein the aligning a feature of each attribute in the target feature of the (j+1)-th image processing model according to the preset attribute arrangement order comprises:
determining an attribute represented by a feature of each dimension in the target feature of the (j+1)-th image processing model; and
adjusting each dimension of the target feature of the (j+1)-th image processing model according to the preset attribute arrangement order.

7.-12. (canceled).

13. An electronic device, comprising:
at least one processor; and
a memory communicatively connected to the at least one processor, wherein the memory stores instructions executable by the at least one processor, and the instructions, when executed by the at least one processor, cause the at least one processor to at least:
input an image to be processed into a first image processing model among N image processing models, so as to obtain an output feature of the first image processing model, wherein the N image processing models are serially connected, and an i-th image processing model among the N image processing models comprises a first shared layer to an i-th shared layer, wherein i=1, . . . , N, and N is a natural number greater than or equal to 2;
input an output feature of a j-th image processing model into a (j+1)-th image processing model, so as to obtain an output feature of the (j+1)-th image processing model, wherein j=1, . . . , N−1; and
fuse the output features of the N image processing models to obtain a fused feature.

14. A non-transitory computer-readable storage medium having computer instructions stored thereon or therein, wherein the computer instructions are configured to cause a computer system to at least:
input an image to be processed into a first image processing model among N image processing models, so as to obtain an output feature of the first image processing model, wherein the N image processing models are serially connected, and an i-th image processing model among the N image processing models comprises a first shared layer to an i-th shared layer, wherein i=1, . . . , N, and N is a natural number greater than or equal to 2;
input an output feature of a j-th image processing model into a (j+1)-th image processing model, so as to obtain an output feature of the (j+1)-th image processing model, wherein j=1, . . . , N−1; and
fuse the output features of the N image processing models to obtain a fused feature.

15. (canceled)

16. The non-transitory computer-readable storage medium according to claim 14, wherein an (i+1)-th image processing model among the N image processing models shares the first shared layer to the i-th shared layer with the i-th image processing model.

17. The non-transitory computer-readable storage medium according to claim 14, wherein the computer instructions are further configured to cause the computer system to add the output features of the N image processing models to obtain the fused feature.

18. The non-transitory computer-readable storage medium according to claim 14, wherein the computer instructions are further configured to cause the computer system to:
input the image to be processed into the first image processing model among the N image processing models, so as to obtain an initial feature of the first image processing model;
process the initial feature of the first image processing model to a preset dimension, so as to obtain a target feature of the first image processing model; and
align a feature of each attribute in the target feature of the first image processing model according to a preset attribute arrangement order, so as to obtain the output feature of the first image processing model.

19. The non-transitory computer-readable storage medium according to claim 18, wherein the computer instructions are further configured to cause the computer system to:
input the output feature of the j-th image processing model into the (j+1)-th image processing model, so as to obtain an initial feature of the (j+1)-th image processing model;
process the initial feature of the (j+1)-th image processing model to the preset dimension, so as to obtain a target feature of the (j+1)-th image processing model; and
align a feature of each attribute in the target feature of the (j+1)-th image processing model according to the preset attribute arrangement order, so as to obtain the output feature of the (j+1)-th image processing model.

20. The non-transitory computer-readable storage medium according to claim 18, wherein the computer instructions are further configured to cause the computer system to:
determine an attribute represented by a feature of each dimension in the target feature of the first image processing model; and
adjust each dimension of the target feature of the first image processing model according to the preset attribute arrangement order;
determine an attribute represented by a feature of each dimension in the target feature of the (j+1)-th image processing model; and
adjust each dimension of the target feature of the (j+1)-th image processing model according to the preset attribute arrangement order.

21. The method according to claim 2, wherein the fusing the output features of the N image processing models to obtain a fused feature comprises adding the output features of the N image processing models to obtain the fused feature.

22. The electronic device according to claim 13, wherein an (i+1)-th image processing model among the N image processing models shares the first shared layer to the i-th shared layer with the i-th image processing model.

23. The electronic device according to claim 22, wherein the instructions, when executed by the at least one processor, are further configured to cause the at least one processor to add the output features of the N image processing models to obtain the fused feature.

24. The electronic device according to claim 13, wherein the instructions, when executed by the at least one processor, are further configured to cause the at least one processor to add the output features of the N image processing models to obtain the fused feature.

25. The electronic device according to claim 13, wherein the instructions, when executed by the at least one processor, are further configured to cause the at least one processor to:
input the image to be processed into the first image processing model among the N image processing models, so as to obtain an initial feature of the first image processing model;
process the initial feature of the first image processing model to a preset dimension, so as to obtain a target feature of the first image processing model; and
align a feature of each attribute in the target feature of the first image processing model according to a preset attribute arrangement order, so as to obtain the output feature of the first image processing model.

26. The electronic device according to claim 25, wherein the instructions, when executed by the at least one processor, are further configured to cause the at least one processor to:
input the output feature of the j-th image processing model into the (j+1)-th image processing model, so as to obtain an initial feature of the (j+1)-th image processing model;
process the initial feature of the (j+1)-th image processing model to the preset dimension, so as to obtain a target feature of the (j+1)-th image processing model; and
align a feature of each attribute in the target feature of the (j+1)-th image processing model according to the preset attribute arrangement order, so as to obtain the output feature of the (j+1)-th image processing model.

27. The electronic device according to claim 25, wherein the instructions, when executed by the at least one processor, are further configured to cause the at least one processor to:
determine an attribute represented by a feature of each dimension in the target feature of the first image processing model;
adjust each dimension of the target feature of the first image processing model according to the preset attribute arrangement order;
determine an attribute represented by a feature of each dimension in the target feature of the (j+1)-th image processing model; and
adjust each dimension of the target feature of the (j+1)-th image processing model according to the preset attribute arrangement order.
